(19) United States
(12) Patent Application Publication
(10) Pub. No.: US 2012/0217759 A1
(43) Pub. Date: Aug. 30, 2012

(54) BATCHES OF ENERGY

(76) Inventor: Joe J. Boyd, Cumming, GA (US)

(21) Appl. No.: 13/035,262

(22) Filed: Feb. 25, 2011

(51) Int. Cl. H02K 7/18; F03G 7/10

(52) U.S. Cl. 290/1 R; 74/DIG. 9

(57) ABSTRACT

This disclosure is based on the fact that when energy is changed, it is changed by batches of work product, and the larger the batch of material, the smaller, proportionally, is the energy. This fact is based on the energy of motion mathematics of dynetics, which derives directly from Galileo's laws of motion, and works all manner of energy problems to exactly comply with the accepted definition of power and energy. Also, it is an accepted fact of physics, that the energy of different branches of physics are convertible, one to another, using a simple constant. This means that the energy of all of these energy sources are developed by work batches. Some of the divisions of physics are shown below.

### BACKGROUND

1. Field of the Invention

The present invention is part of the broad field of generated energy, but relates to the sizes of the batches of generated energy and not to the method of generation. In particular, it uses the principle of the new math of Dynetics, wherein large batches of work use or produce less energy than the same total amount of work when used in small batches, and if one applies energy to stow potential work in one large batch and then converts it back into energy in a number of small batches, he increases the total amount of energy available.

2. Description of the Related Art

The statement (above) that the total amount of energy is increased, is counter to the so called law that states that (Energy can not be made nor destroyed). But this law was postulated by scientists who didn't even have the true law of kinetic energy, and who said that the old kinetic energy law was correct even when its answers were completely wrong according to the universally accepted definition of power and energy. This definition is: The energy generated the first second is the power, and the energy generated each second thereafter is the power times the time.

The scientist knew that the math of kinetic energy did not solve for the true energy of kinetics, but they also knew that if the velocities were kept low, that the energy found by the old energy formula was close when only local velocities were used. The problem was that if any outside velocities, like those of a train, airplane or automobile, that were added to the local velocities, the error of the old kinetic energy equation became very high, and if the speed of the earth around the sun was added to the local velocities, the error of the kinetic energy equation became astronomical. In the early 1900s the scientists postulated a number of laws that were never completely accepted. The scientists put what they called a frame of reference around the old kinetic formula to keep out the outside velocities, so that they could get answers acceptable for local problems. This gave them a usable energy formula, even though wrong, but as time went by they began saying that the formula was correct and that the outside velocities were unpredictable, erratic and chaotic. This farce has gone on for over 100 years, and most professors now considered both postulations true. The velocity of bodies, however, is probably one of the most predictable of God's creations.

### Energy Out of the Earth

It seems likely that when a force moves a weight, that it uses energy which comes right out of the earth. Also, to transfer energy from body A. to body B., body A. must do an amount of work on body B. that requires exactly the same amount of energy that is transferred. When a body exerts a force to lift a weight to a height, it uses energy to do work, but the weight gains exactly the same amount of energy. When the force stops, the energy stops, but the weight now has all of the energy used in the work that raised it to the elevated position; and if the weight is dropped back again, all of the energy used to raise the weight to a height and to re extract the energy, is now in the form of velocity in the weight. If the weight is stopped using an apposing force, the energy of the force will exactly equal that put in by the force that raised the weight to the height, and the weight, in turn, must do work to produce the energy needed to stop.

Other examples of how different types of work produce energy are: The small filament in a light bulb, when heated to a white heat, produces beam of light of such power that it will go to the moon, and a small radio transmitter uses high frequency oscillations between the earth and an aerial that generates a signal strong enough to go around the earth. Also the discharge of an electric charge between clouds and the earth produces such power that the discharge lightning is a white hot streak, that will destroy a house and it produce thunder that is almost deafening. The work energies of a lightning bolt are electric, light, mechanical, heat and sound. It is doubtful that all clouds are full of these energies. They are just generated as needed.

### Dynetic Energy Formulae

The principle that we can store a certain amount of energy in a large batch of material and then take more energy out in smaller batches of the same material, is shown in the energy mathematics of dynetics. The primary formulae of dynetics that work the energy problems are shown below:

$$\begin{matrix}Dynetic Energy = \sqrt{\frac{F 32 S}{2}} \\ = \sqrt{\frac{W a S}{2}} \\ = \frac{F 32 t}{2 \sqrt{W}} \\ = \frac{\sqrt{W} V}{2} \\ = \frac{\sqrt{W} S}{t} \\ = Lbs . ft . / sec .\end{matrix}$$

Where the:
F=force, lbs.
S=distance, ft.
W=weight, lbs.
V=velocity, ft./sec.
t=time, sec.
g=acceleration of gravity,
a=acceleration of the weight.

### The Purpose of these Formulae

These formulae take the square root of the batches of work (a batch of material containing a force or a weight moving a distance). The formulae work all of the problems of kinetic energy and potential energy correctly.

The first two formulae are the poten formula. They solve all types of energy problems. The force F. is the average force acting each second, the acceleration g, is the acceleration of gravity, the distance S. is the distance per second, and the products of these values are the “batches”. The square root of a batch gives us the power (energy per second). If the total distance is used, we get the total energy. In the second formula, the weight W. and its acceleration (a) can be used in place of (F32) in the first formula. The energies found by these formulae are pounds feet per second, and the energy in the first second is power.

The third formula above is the poly-dyna formula, and it generally goes with the velocity and the distance formulae, but it does equal the poten formulae. It does not have an over all radical sign, but its energy varies directly as the velocity and it always agrees exactly with the poten formulae.

The next formula is the velocity formula, and its energy varies as the square root of the weight and directly as one-half of the velocity, in the first second it solves for the power, and each second thereafter it solves for the energy. The velocity energy varies directly as the time.

The last formula is the distance energy which varies as the square root of the weight and directly as the distance divided by the time.

### The Dynetic Formula Finds the True Energy

The old kinetic energy formula does not give answers that fit the definition of energy that is universally accepted. This definition is: power is the energy per second, and the total energy is the power multiplied by the time.

In a problem worked by a true kinetic energy formula, the energy found for the first second will be the power, for the second second, the energy will be two times the power, for the third second, it will be three times the power, and so forth

Any dynetic formula will give answers that agree with this definition. Use the velocity of a falling weight to show this: it is basic knowledge that a freely falling body increases its velocity by 32 ft./sec. each sec. We can use this fact to check the energy of the dynetic velocity formula. Bring down the formula and use a weight of 4 lbs. to find the energy:

$$Velocity energy E = \frac{\sqrt{F} \times V}{2} = ft . / sec . \\ First second energy E = \frac{\sqrt{4} \times 32}{2} = 32 ft . lb . / sec . \\ Second second energy E = \frac{\sqrt{4} \times 64}{2} = 64 ft . lbs . / sec . \\ Third second energy E = \frac{\sqrt{4} \times 96}{2} = 96 ft . lbs . / sec . \\ Fourth second energy E = \frac{\sqrt{4} \times 128}{2} = 128 ft . lbs . / sec .$$

Notice that the energy increased 32 ft.lbs./sec. each second. Now check the distance formula. We know that the distance that a weight falls in free fall is 16 ft. the first second and that the distance increases by the square of the time each second after that. This amounts to 16 ft. the first second, 64 ft. the second second, 144 ft the third second and 256 ft. the forth second. Bring down the dynetic distance formula.

$$Distance energy = \frac{\sqrt{W} \times S}{time} = ft . lbs . / sec . \\ First second energy = \frac{\sqrt{4} \times 16}{1} = 32 ft . lbs . / sec . \\ Second second energy = \frac{\sqrt{4} \times 64}{2} = 64 ft . lbs . / sec . \\ Third second energy = \frac{\sqrt{4} \times 144}{3} = 96 ft . lbs . / sec . \\ Fourth second energy = \frac{\sqrt{4} \times 256}{4} = 128 ft . lbs . / sec .$$

The energy of the distance formulae came out the same as the energy of the energy of the velocity. The answers worked by the other formulae of dynetics would be the same. Now work the problem by the old kinetic energy formula. The weight is 4 lbs. and the velocity increases 32 ft/sec. each second, and weight moves 16 ft, the first second, 64 ft. the second second, 144 ft, the third second and 256 the fourth second. Bring down the old kinetic energy formula;

$$Energy = F \times S = \frac{W \times {V}^{2}}{2 \times 32} = ft . lbs . / sec . \\ First second energy = 4 \times 16 = 64 ft . lbs . , \\ Energy = \frac{4 \times {32}^{2}}{2 \times 32} = 64 ft . lbs . \\ Second second energy = 4 \times 64 = 256 ft . lbs . , \\ Energy = \frac{4 \times {64}^{2}}{2 \times 32} = 256 ft . lbs . \\ Third second energy = 4 \times 144 = 576 ft . lbs . , \\ Energy = \frac{4 \times {96}^{2}}{2 \times 32} = 576 ft . lbs . \\ Fourth second energy = 4 \times 256 = 1024 ft . lbs . , \\ Energy = \frac{4 \times {128}^{2}}{2 \times 32} = 1024 ft . lbs .$$

In the two proofs using the dynetic energy formulae, the power came out as 32 and increased as 32 each second. This is in exact agreement with the standard definition of power and energy.

The energy math of the old energy of kinetics, using the same values, however, finds that the power is 64 ft.lbs., and that the increase energy the second second is 256 ft.lbs., the third second is 576 ft.lbs. And the fourth is 1024 ft.lbd. This shows that the energy increases each second as the square of the time, instead of as a multiple of the time.

### The Importance of the Batches

Notice that we must take the square root in the poten formulae to get the energy. This means that the energy varies, not as the force and distance vary, but as the square root of force and distance vary. This separates the energy into batches and the larger the batch, proportionally, the smaller the energy. The square root of 100 is 10. The square root 10 is 3.162. The square root of 3 is 1.73. The square root of 1.0 is 1.0. Notice this. The square root of 100 is 10, and the square root of 1.0 is 1.0.

This means that if we take one half of the force, say, we reduce the product of that batch by one-half, but we only reduce the energy of that batch by the square root of two (1.414). And that if we use one forth of any unit in the batch, it reduces the product to one-forth, but it reduces the energy to one-half. We can increase or decrease the batches, as we please, but when we do, we only change the energy by the square root of the change in the batch.

As an example of the batches changing the energy, let's use a quantity of energy to stow a large batch of work product and then take the energy out using smaller batches. Use F=8 lbs. and S=10 ft. in the large batch, so that the large batch is: 8×16×10=1280 lbs.ft.²/scc²

$$\begin{matrix}The energy of the large batch = \sqrt{\frac{8 \times 32 \times 10}{2}} \\ = 35.78 lbs . ft . / sec .\end{matrix}$$

If we reduce the force to 4 lbs, and the distance to 5 ft., the amount of the small batch is: 4×16×5=320 lbs.ft./sec.

$$\begin{matrix}The energy of the small batch = \sqrt{\frac{4 \times 32 \times 5}{2}} \\ = 17.89 lbs . ft . / sec .\end{matrix} \\ The number of small batches available = \frac{1280}{320} = 4$$

The total energy of the small batches=4×17.89=71.56 lbs.ft./sec.

We put 35.78 lbs.ft./sec. in one large batch, broke it into 4 smaller batches and got 71.56 lbs.ft./sec. out. This doubled the energy. We could go further and triple the energy or quadruple the energy. The small batches may be of different sizes.

The different energies like electric, chemical, heat, etc. have conversion factors to equate them to the mechanical energy. For instance the math books convert the electric energy, Onejoule=0.7376 foot pounds.

A “batch of products” as used here, is the quantity shown under the radical signs, and if an equivalent batch of products, say electrical, can be equated to it just using a conversion factor, the electrical products must also be in batches.

### Derivation of the Dynetic Energy Formula

All of the energy formulae of dynetics are derived directly from Galileo's formula. Here we have the derivation of the poten formula and the velo formula. Bring forth one of Galileo's velocity formulae.

$$Velocity V = at = 32 \frac{{F}_{T} t}{{W}_{T}} = ft . / sec .$$

Solve for the time t;

$$Time t = \frac{{W}_{T} V}{{F}_{T} 32} = sec .$$

Bring down the distance formula:

$$Distance S = \frac{{at}^{2}}{2} = \frac{{F}_{T} 32 {t}^{2}}{2 {W}_{T}} = ft .$$

Solve for t²:

$${t}^{2} = \frac{2 {W}_{T} S}{32 {F}_{T}} = sec {.}^{2}$$

Take the square root to get time:

$$Time t = \sqrt{\frac{2 {W}_{T} S}{{F}_{T} 32}} = sec .$$

Take the V-time formula and the S-time formula and equated them.

$$Time t = \frac{{W}_{T} V}{{F}_{T} 32} = \sqrt{\frac{2 {W}_{T} S}{{F}_{T} 32}} = sec .$$

The two sides are equal to t, and equal to each other. The force energy equals the weight energy as is seen in the work formula (F 32 S)=(W a h) that Galileo used when he rolled weights down an inclined plain. In the above equation transfer the (Wa) and (F32) to opposite sides, so that the work equation is intact.

$$Time t = \frac{{W}_{T} V}{2 \sqrt{{W}_{T}}} = F 32 \sqrt{\frac{S}{2 {F}_{T} 32}} = sec .$$

Now simplify, and we have the velocity formula and the poten formula

$$Dynetic Energy = \frac{\sqrt{{W}_{T}} V}{2} = \sqrt{\frac{{F}_{T} 32 S}{2}} = lbs . ft . / sec .$$

The combined velocity and the distance equation give two new energy formulae, the poten formula and the velo formula. These formula are two of the true energy formulae of kinetic motion.

The velocity formula finds the velocity energy, and the poten formula works all kinds of force and distance problems. These formulae meet all of the energy requirements.

Now check the relationship of the new dynetic formulae to the old kinetic energy formulae:

Dynetic Energy=Square Root of Kinetic Energy

The old inertia formula that Galileo used to prove his kinetic motion formulae is F g S=W a h, where F=force, (g) is the acceleration of gravity, (S) is the distance, (W) is the weight, (a) is the acceleration of the weight, and the (h) is the height that the weight falls. This is a basic equation of kinetics and the parts have meaning only when used as an equation. One of our greatest scientists, Sir Isaac Newton, made a slip-up when he separated the gravity acceleration (32) from the force (F) and moved it over to the opposite side of the equation and divided it into the weight, forming what he called “mass=F/32”. This rendered the inertia equation useless as an equation of kinetics except to find the force. To make the kinetic energy equation a part of kinetics the acceleration of gravity should always be put back with the force.

Bring down the kinetic energy equation, and put the (32) with the F where it is supposed to be, and also divide both sides by another two, so that we take one-half of the velocity, or one-fourth of the velocity squared.

$$Corrected Kinetic Energy = \frac{{W}_{T} {V}^{2}}{4} = \frac{F 32 S}{2} = ft . lbs .$$

Now, take the square root of both sides of the kinetic energy formula and you have the dynetic energy formulae. This is exactly what I derived from Galileo's formulae.

$$Kinetic Energy = \frac{\sqrt{{W}_{T}} V}{2} = \sqrt{\frac{{F}_{T} 32 S}{2}} = ft . lbs . / sec .$$

And the dynetic energy equation is exactly equal to the square root of the corrected old kinetic energy equation.

### BRIEF SUMMARY OF THE INVENTION

This disclosure is based on the fact that when energy is changed, it is changed by batches of work product, and the larger the batch of material, the smaller, proportionally, is the energy. This fact is based on the energy of motion mathematics of dynetics, which derives directly from Galileo's laws of motion, and works all manner of energy problems to exactly comply with the accepted definition of power and energy. Also, it is an accepted fact of physics, that the energy of different branches of physics are convertible, one to another, using a simple constant. This means that the energy of all of these energy sources are developed by work batches. Some of the divisions of physics are shown below.

Gravity: If the energy is gravity energy, we can get more energy out than we put in by lifting a large batch a distance against gravity and dropping it back in small batches. The weight may be a fluid or a solid and when separated into small batches and dropped back the original distance, they may be dropped back in stages. The small batches might have velocity energy, do work, or generate electricity.

Inertia: To move a weight we must exert a force against the weight and store the energy in velocity, the distance moved or potential work. The force is the force F in the poten formula.

Pressure: If the force is acting against a pressure, it is generally based on the cross sectional area of a pipe or a piston. With a reciprocating pump we need the R.P.S. and the stroke. With a fluid moving in a pipe, (W a) can be used instead of (F 32).

Chemical: Internal combustion engines and steam engines may be listed as chemical, as well as the animal work.

Below are listed a few of the many ways that the batches of work generated energy may be used.

Hydro-electric power plant: 1. Reducing the sizes of the turbine and generators. 2. Pumping the water back up with a big pump and taking the energy out with small turbines. 3 Dropping the water down in stages, with the turbines located at each stage to take out the energy.

Small plants, cities, and businesses can use the methods listed above and pump water to a tank on a tower and take the energy out in small work batches. Or those who need the added power could use the pressure type work batches, and could store the gas or a fluid under pressure in a tank. The electric type work batches might use a number of batteries, where the large batch is a high voltage high amp charge, which is taken out in small batches by using the batteries separately.

Vehicle Power: Lighter equipment is needed for powering automobiles and this fits right in with small motors using small batches of energy. The small batches can be used to supply small motors to drive the auto, and take advantage of the increased energy.

Also, the small motors then would give an additional advantage, since they could be added to, or cut out of the drive chain as needed. A high torque motor could be used for starting and then cut out when the car gets up to speed. Two additional inline motors could then take over, one for city driving and the other for open highway travel. The motors might need over-running clutches, or jaw clutches, and not run when not needed. To charge the batteries they could be hooked up in series and charged and separated out to drive the small motors, to increase the available energy.

Not only can the batches work principle be used to multiply the energy output of various type power plants, it makes possible “stand alone” plants based altogether on the energy batches principle. Cities, large companies or individuals with sources of energy can use batches to supply their energy needs.

### BRIEF DESCRIPTION OF THE FIGURES

FIG. 1. shows an outline of method of using energy to do work to increase the total amount of available energy. A large batch of work is changed by energy to a higher position of potential, and is then separated into two or more smaller batches, and brought back to the original potential. The total energy extracted from the small batches is greater than the total energy put into the big batch.

FIG. 2. is a view of a large batch of work (in this case, force times distance) raised to a height above the ground (work-done), in a gravity field, and where the work-done is divided into two or more smaller batches, and where, when the smaller batches are dropped back the distance lifted, and the total energy extracted from the smaller batches is greater than the total energy put into the large batch,

FIG. 3. is a view of a batch of work raised to a height above the ground, giving the work-done a position of higher potential, and then separated into smaller batches, which are dropped back down in stages, and at each stage the energy is extracted. By dropping the weight in stages, the total energy extracted is greater, since the total square roots of the work of each stage, is proportionally greater than the square root of the total weight or the square root of the same small weight dropped the full distance.

FIG. 4. shows a view of the equipment used to extract energy from a large batch of fluid compressed against a gas and stored in a tank, and then used in smaller batches, to increase the total energy available. The type of gas compressed and stored in the tank is of no interest here, except that the gas compress and expand in a normal manner. The important thing is that large batches of fluid be stowed in the tank, and taken out in small batches. This is a typical example of the way spring type forces increase the energy when large stowed batches are broken into small batches and the energy extracted.

FIG. 5. is an electric set-up for the home, where a number of batteries are charged with 110 volt A. C. current to make a large batch of stowed energy, and then the batteries are separated into a smaller number to form small batches to supply the lights and utilities. A set-up of this type can reduce the energy used by as much as one half or one quarter.

There is old art where the batteries are hooked up in series to charge them, and then hooked up in parallel to use the power. But the intention and results of that invention are entirely different to the present invention. They charge the batteries with high voltage, 110 volts, and low amps. Then they hook the batteries up in a parallel circuit, to drive a golf cart, a lawn mower, or a garden plow. The small batch in this case drives a big motor and although the voltage has been reduced for safety the current is increased to drive the big motor. The small batch may be as big as the large batch, and would not increase the energy at all.

### DETAILED DESCRIPTION

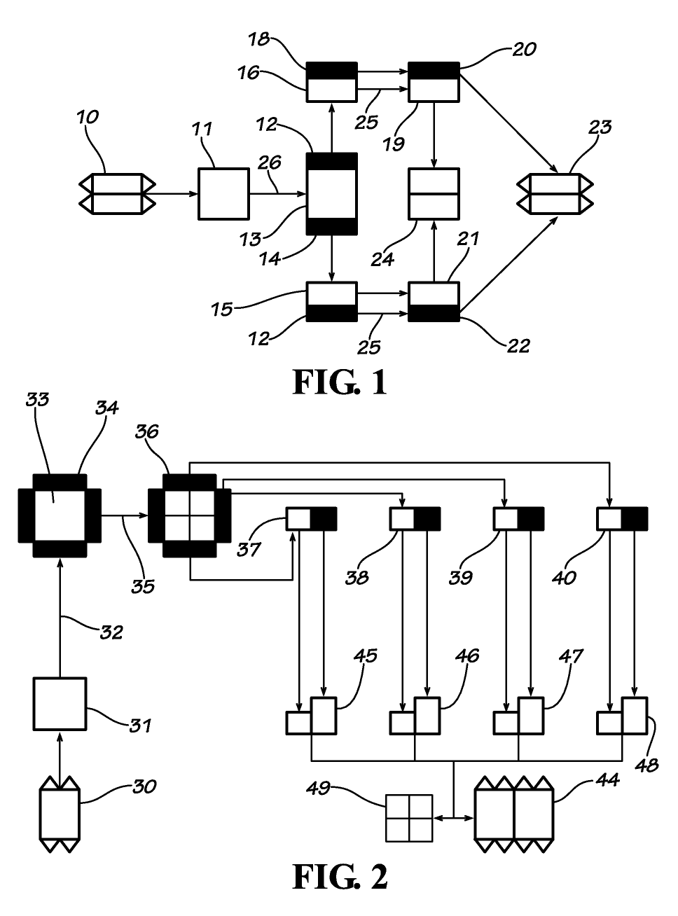

The basic principle making possible the amplification of energy by using energy to drive large batches of work product, and breaking the large work-done batches into smaller work-done batches, and extracting the energy. This is shown in FIG. 1. A quantity of energy 10. does work to move 11. against a resistance 26. to stow the work in the batch 13. The stowed energy product is now in the form labeled “work-done” 13., where the work product 11 is altered by the energy 10., and this is shown by the shaded sections 12. and 14. on batch 13. The large batch 13. is now divided into a number of smaller batches. In this case the number is two. The smaller batches are 15 and 16, and their energy alterations are 17. and 18. The two small batches are now processed to extract their energy, and the energies 20. and 22. are extracted from the small batches 15. and 16., leaving the total work product 24. the same as 11. that we started with. The energies are added at 23. The work-done broken into two parts would give an increase of 1.414 more energy. If broken into four parts, the energy would be twice that put in, and if broken into 16 parts the energy would be 4 times as great.

In FIG. 2. a weight is lifted against gravity, then broken into four parts and dropped again to extract the energy. Using the amount of energy 30. the weight work product 31. is raised against the gravity force for a distance 32 to produce a large work-done batch 33. with the energy alterations 34. shown around it as the shaded parts. Now the large work-done batch 36. is separated into a number of smaller batches, in this case 4 batches. The small work-done batches are numbered 37., 38., 39., and 40., and the shaded parts show that they have been energy altered. The small batches are now dropped back down, and the energy altered weight converts back to energy in units 45., 46., 47. and 48. The forces are now added at 49., and are the same amount that we started with at 11. The energies are added to make energy 50., and they are twice the input energy 30.

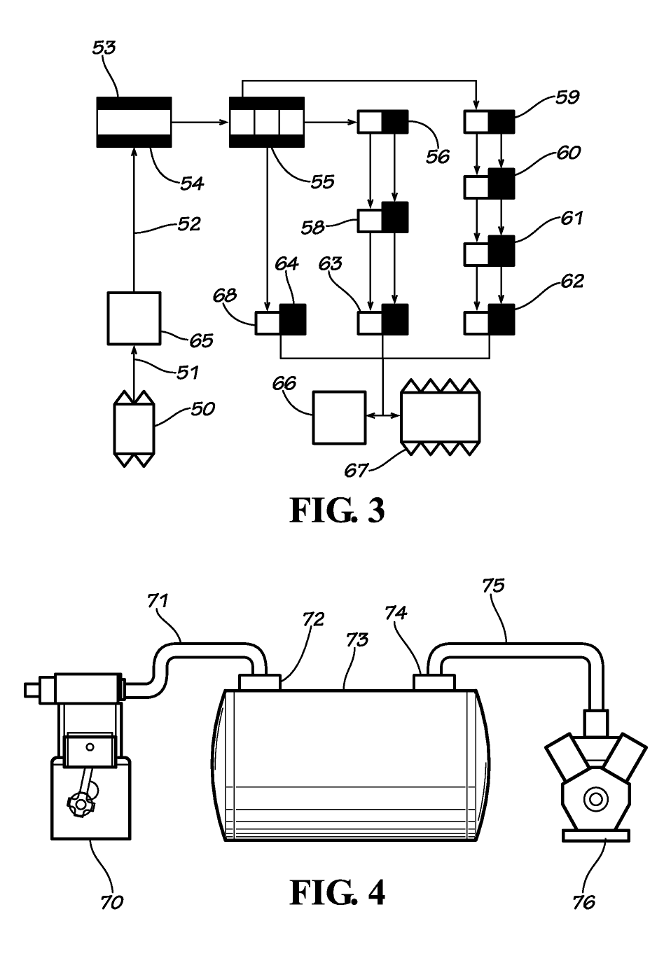

In FIG. 3. we have lifted another weight 65. with the energy 50. to a distance 52., giving it an increased potential as batch 55. Then the batch 55. is separated into separate, smaller batches, in this case three, and each smaller batch is dropped back, the original distance lifted. The first weight 68. is dropped the full distance, and the second weight 56. is dropped half the distance down to 58. and the energy is extracted and then dropped the rest of the way down to 63. and the energy extracted again. The third weight 59. is dropped in three stages and the energy is extracted at each stage. These stages are 59. 60. 61. and 62. Here, we show one small batch falling back the full distance, a second small batch falling down in two stages, and a third batch falling down in three stages.

If the weight is 4 lbs., and the height lifted is 12 feet, the energy put in is 27.7 lbs.ft./sec. The energy taken out of the first batch is 13.9 lbs.ft./sec, the second is 19.6 lbs.ft./sec., the third is 24 lbs.ft./sec. The total energy of the small batches is 2.8 times the input energy. Had all three of the small batches dropped through three stages, the total energy extracted would have been 72 lbs.ft./sec., three times that put in.

FIG. 4. shows a means of applying gas pressure to a fluid as a method of extracting more energy from a large batch of stored fluid under pressure than was put into it. The pump 70 drives a large batch of fluid against compressed gas in large tank 73., and transfers it through the pipe 71 and check valve 72. Then as the power is needed, the control valve 74 opens to feed high pressure air through the pipe 75 to the multi-cylinder air engine 76, or to other small tools. If the unit is used to drive a vehicles the compressor 70 would need be one large cylinder unit, while the driven motor could be v-eight or a v-twelve. This should give a 2.5 to 3 times increase in power used.

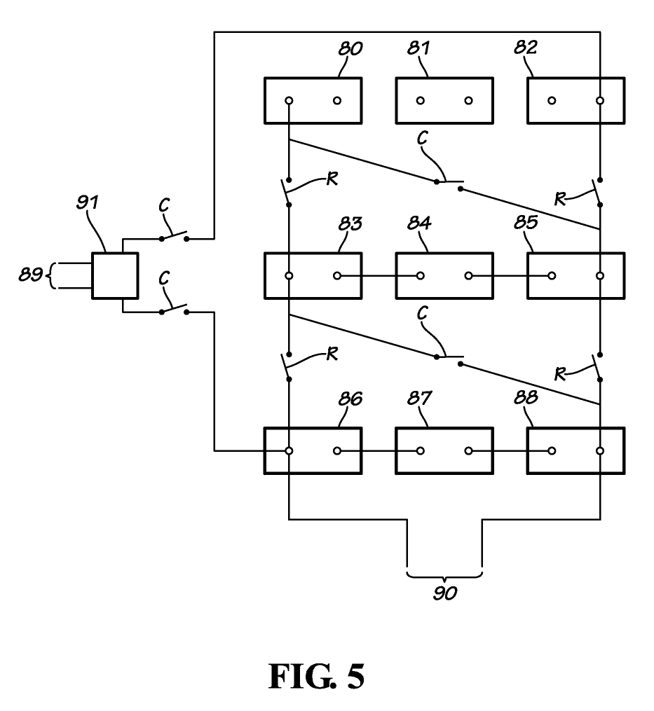

FIG. 5. shows an arrangement for extracting energy from lights and other equipment in a home. The house current is fed in at 89, rectified at 91., stowed in large charge batches and taken out in smaller batches at 90., which is coupled to the house wiring circuit to supply the home utility equipment. These batteries, charged by the house current, supply the low volt, low amp needs of the many small batches of power needed in the home. When the batteries are to be charged, the switches marked “C.” are closed and the switches marked “R.” are open. Then when the charging is complete the “C.” switches are opened again, and when the power is needed, the “R.” switches are closed.

In charging, the batteries are connected in series, and when supplying the home needs they are separated into groups of smaller batches and these batches are connected in parallel, and the each small batch may contain one or more batteries, depending on the voltage needed.

What is claimed is:

1. A method based on the mathematics of dynetics, where the work is done in batches, and where the square root of the work batches use or supply the energy that does the work, and where the large work batches use or supply proportionally less energy than the smaller work batches, and where this principle is applied by stowing large work batches in energy high potential locations, and where the material of each large stowed batch is separated into smaller batches, which are converted back to energy and used, so that the total energy of the small batches is greater than the total energy put into the large batch.

2. The method of claim 1, where the large work batch is a weight lifted in a gravity field, which is then separated into two or more small batches and dropped back to extract the energy. Some small batches fall back the full distance to extract the energy, and others fall back in stages, extracting the energy at each stage.

3. The method of claim 2, wherein the material of the batch is a liquid which is pumped to an elevation and stored in a lake or a tank, and the liquid is separated into small batches, and the energy is extracted by small turbines or reciprocating motors that drive generators and do other work.

4. The method of claim 1, where a large batch of fluid is forced against an elastic force under pressure to store it, and where the large batch is separated into smaller batches and the energy is extracted, so that the total energies of the small batches are greater than the total energy of the large batch.

5. The method of claim 1, where large batches of weight are given a velocity, and then the speeding weight is separated into smaller batches of weights, and the energy is extracted, so that the total energies of the products of the small batches are greater than the total energy of the products of the large batch.

6. The method of claim 1, where large batches of gas are compressed and stored, and then separated into smaller batches, where the energy is extracted, so that the total energies of the products of the small batches are greater than the total energy of the products of the large batch.

7. The method of claim 6, where, when the large batches of gas are separated into smaller batches and the energy extracted, it is done in pressure stages so that the total energies of the small batches are greater than the total energy of the large batch.

8. The method of claim 1, where the energy is electric energy and large generated batches of electric energy based on high voltage or high amperes, or both, are stored in batteries or on line, so that when the energy is used it may be separated into smaller batches of lower voltage or amperes or both in order to increase the total energy.

9. The method of claim 1, where the large generated batches of electric energy have higher voltages or amperes, or both, and are stored in batteries of many cells, hooked in series, so that when the energy is used, the cells may be connected in parallel, or be separated into smaller batches of lower voltage or amperes or both, in order to increase the total energy.

10. The method of claim 8, where the small batches of energy separately drive small motors and where the motor's shafts may be coupled together with the motors in line, or parallel, or a number of motors may be made on the same shaft. to increase the torque, and to fully utilize the increased energy of the small batches.

11. The method of claim 1, where a vehicle engine drives two or more large batch set-ups, and where the energy is stored in large batches and used in small batches, and where the batch set-ups may alternately power the vehicle, or are recharged as needed.
